(19) United States
(12) Patent Application Publication
(10) Pub. No.: US 2024/0248173 A1
(43) Pub. Date: Jul. 25, 2024

(54) REFLECTOMETRIC SYSTEM AND METHOD FOR MEASURING VIBRATIONS OR DEFORMATIONS OF OBJECTS/STRUCTURES

(71) Applicant: ENI S.P.A., Roma (IT)

(72) Inventors: Alessandro SERENA, San Donato Milanese (MI) (IT); Giuseppe GIUNTA, San Donato Milanese (MI) (IT); Andrea Virgilio MONTI-GUARNIERI, COMO (IT); Marco MANZONI, Galbiate (LC) (IT)

(21) Appl. No.: 18/564,343

(22) PCT Filed: May 26, 2022
(86) PCT No.: PCT/IB2022/054968

§ 371 Date: Nov. 27, 2023

(30) Foreign Application Priority Data
May 28, 2021 (IT) 102021000014027

(51) Int. Cl. G01S 7/41; G01S 13/50; G01S 13/75; G01S 13/88

(52) U.S. Cl. CPC G01S 7/415; G01S 13/50; G01S 13/75; G01S 13/88

(57) ABSTRACT

A reflectometric system and method for the measurement of deformations and/or vibrations of an object/structure includes a radar device for transmitting a radar signal to at least one target associated with the object/structure, the target being a vibrating target with a mechanical vibration mechanism equipped with an electric motor group to generate a self-induced motion with respect to the object/structure. The at least one vibrating target vibrating with its own frequency of induced vibration, modulating the radar signal at least on the basis of its own frequency of induced vibration to generate a return signal received by the radar device as part of a complex signal. The complex signal is processed to determine an identification signal of each vibrating target using its own frequency of induced vibration; the measurement of deformations and/or vibrations determined for each vibrating target on the basis of a phase value extracted from the identification signal.

### CROSS-REFERENCE TO RELATED APPLICATIONS

This application is a 35 U.S.C. § 371 National Stage patent application of PCT/IB2022/054968, filed on 26 May 2022, which claims the benefit of Italian patent application 102021000014027, filed on 28 May 2021, the disclosures of which are incorporated herein by reference in their entirety.

### TECHNICAL FIELD

The present disclosure refers to a reflectometric system for measuring vibrations or deformations of objects/structures.

The disclosure specifically refers to a reflectometric system comprising a radar device that transmits a radar signal to at least one receiving device or target associated with the object/structure.

The present disclosure also relates to a method for measuring vibrations or deformations of objects/structures.

The method and system described provide vibration or deformation measurements with sub-millimetre accuracy and sensitivity and with response times down to milliseconds. Possible fields of application are for example: industrial plants for the production of energy such as wind turbines, petrochemical plants, gas compression stations, thermoelectric plants, dams and penstocks, offshore platforms, refineries, storage tanks, bridges and viaducts, monuments, historic buildings, etc.

### BACKGROUND

Various systems and methods are known for monitoring and providing precise vibration or deformation measurements of large objects/structures. These monitoring activities can be carried out using devices that, arranged remotely with respect to the object or structure to be monitored, allow for the detection of images, acoustic signals or optical signals.

It is well known in the case of objects/structures such as tanks, bridges, offshore structures and other similar large-sized structures, the monitoring by reflectometric techniques which are based on transmitting radar signals to the object/structure and on the analysis of the return signals. For this purpose, reflective or target devices are also used, which can be active or passive and which, associated with the structure, allow, at least locally, for the visibility of the object or structure to be improved and for the radar signals received to be reflected. The contribution of the receiving devices must be separated from the disturbing signals generated by interfering structures or objects to be analysed by the radar detection device. In the case of receiving devices or targets placed in the same resolution cell, i.e., at the same distance from the radar detection device, as shown schematically in FIGS. 1 and 2, there is an overlap of the return signals—in module and phase. Therefore, the return signals of each target cannot be separated easily and, in presence of interfering signals, also in the same resolution cell, the complexity of the separation increases.

A known solution for processing the return signal is described in European patent No. EP2937710B1, granted on 14 Mar. 2018 and filed by the present Applicant, relating to a kinematic calibration method for measuring displacements and vibrations of objects/structures. The calibration technique separates the interfering signals from the reflected signal by inducing, in the reflected signal, for a predetermined period of time, a vibration of a known duration and frequency which allows for the interfering signals to be estimated by means of a statistical technique based on the phase term of the induced vibration.

Other solutions use reflectors such as transponders with codes, radio frequency tags or RFID tags that allow the systems and methods used to analyse return signals that can be identified in phase or amplitude with respect to the signals transmitted by radars.

Even these solutions, albeit satisfactory under various aspects, have some drawbacks. In fact, in some cases, the sensitivity of the systems and methods is subject to additional delays due to the electronic components used which have a considerable impact on the measurements obtained. Furthermore, said systems and methods of analysis are often complex and expensive.

### SUMMARY

The present disclosure devises and provides for a system and a method for estimating the effective and rapid measurement of deformations and vibrations of an object/structure, even in the presence of two or more reflecting devices placed in the same resolution cell, with the desired characteristics of sensitivity and accuracy and with structural and functional characteristics such as to solve the technical problems highlighted, thus overcoming the drawbacks mentioned with reference to the prior art.

The solution idea underlying the present disclosure is to estimate the deformation or vibration measurement of the object/structure by imposing known vibrations on said reflecting devices or targets.

On the basis of this solution idea, the present disclosure relates to a reflectometric system for measuring vibrations or deformations of an object/structure, the system being equipped with a radar device suitable for transmitting a radar signal to at least one target associated with the object/structure, said at least one target being a vibrating target comprising a vibration mechanism equipped with an electric motor group to generate a self-induced motion with respect to said object/structure with its own frequency of induced vibration, said at least one vibrating target modulating said radar signal at least on the basis of said its own frequency of induced vibration to generate a return signal; the radar device being connected to a processing unit for receiving and processing a complex signal comprising said return signal and for extracting, from said complex signal, an identification signal of said at least one target vibrating on the basis of said its own frequency of induced vibration, said processing unit estimating said measurement of deformations and/or vibrations on the basis of the phase value of said identification signal of said at least one vibrating target.

Advantageously, said at least one vibrating target comprises a control unit equipped with a microprocessor to control its own frequency of induced vibration, which is induced by the electric motor group, said at least one vibrating target further comprising a reflecting device that is a passive reflector type or an active reflector type comprising an amplification unit.

Conveniently, the vibration mechanism is configured to determine the self-induced motion with a half-oscillation range greater than zero and not greater than 0.2 times the wavelength of said radar signal, preferably the half-oscillation range is not greater than 0.1 times the wavelength of the radar signal.

Said at least one vibrating target comprises a measurement module equipped with at least one environmental sensor, an accelerometer and/or an inclinometer and/or comprising a wireless module configured to receive/send signals from/to said processing unit, said measurement module and/or said wireless module being controlled by the control unit.

Conveniently, the processing unit comprises a processing module equipped with a processing branch for each of said at least one vibrating target, each processing branch comprising:
a filtering unit equipped with a bandpass filter that filters said complex signal on the basis of its own frequency of induced vibration generating said identification signal; and
a phase estimation module comprising a phase term extraction unit suitable for extracting the phase term of said identification signal and an unwrap unit which allows for an estimate of said measurement from said phase term to be defined.

The disclosure also relates to a method for measuring displacements, vibrations or deformations of an object/structure comprising a measurement step which provides for transmitting at least one radar signal from a radar device to at least one target associated with said object/structure, the method providing of:
equipping said at least one target with a vibration mechanism comprising an electric motor group to generate at least one vibrating target with self-induced motion with respect to said object/structure, said at least one vibrating target having its own frequency of induced vibration;
generating return signals by modulating said radar signal at least on the basis of said its own frequency of self-induced vibration of said at least one vibrating target;
receiving and processing a complex signal comprising said return signal;
extracting from said complex signal an identification signal of each at least one vibrating target on the basis of said its own frequency of induced vibration;
determining a phase value of said identification signal of each at least one vibrating target; and
estimating said measurement of deformations and/or vibrations in correspondence with each at least one vibrating target on the basis of said determined phase value.

Advantageously, the method provides for controlling said its own frequency of induced vibration of said electric motor group by means of a control unit equipped with a microprocessor and providing said at least one vibrating target with a reflecting device which is a passive reflector type or an active reflector type comprising an amplification unit.

Conveniently, the method provides for determining the self-induced motion with a half-oscillation range greater than zero and not greater than 0.2 times the wavelength of said radar signal, preferably, the half-oscillation range is not greater than 0.1 times the wavelength of the radar signal.

The method comprises: the separate processing of said complex signal for each of said at least one vibrating target by providing of:
filtering said complex signal with a bandpass filter on the basis of said its own frequency of induced vibration to generate said identification signal;
extracting a phase term of said identification signal and identifying a continuous profile of said phase term by means of an unwrap unit.

The method provides for determining the phase term by extracting a number (Nc) of consecutive samples from said identification signal and maximising the counter-rotated identification signal of said phase in the real squared part.

The method provides for estimating said measurement by processing two or more vibrating targets belonging to the same resolution cell.

The characteristics and advantages of the reflectometric system and of the method according to the disclosure will result from the following description of a preferred embodiment given by way of indication and not of limitation with reference to the attached drawings.

### BRIEF DESCRIPTION OF THE DRAWINGS

In such drawings:

FIGS. 1 and 2 show, schematically and respectively, a reflectometric system with two targets in the same resolution cell and a representation in the complex plane of two return signals sent by the two targets at the same time (t);

FIG. 3 schematically shows a reflectometric system made according to the present disclosure;

FIGS. 4 and 5 show, with block diagrams, a first and a second embodiment of a target made according to the present disclosure;

FIG. 6 schematically shows three examples of return signals, reflected or transmitted by a target made according to the present disclosure;

FIGS. 7 and 8 show, respectively, a block diagram and a representation, in the complex plan, of some steps of the method according to the present disclosure;

FIG. 9 shows with a block diagram a simulation of the method of FIG. 7;

FIGS. 10 to 18 show some graphs relating to a simulation of the method according to the present disclosure; and

FIGS. 19-21 show, in perspective schematic views, some examples of use of the system and method according to the present disclosure.

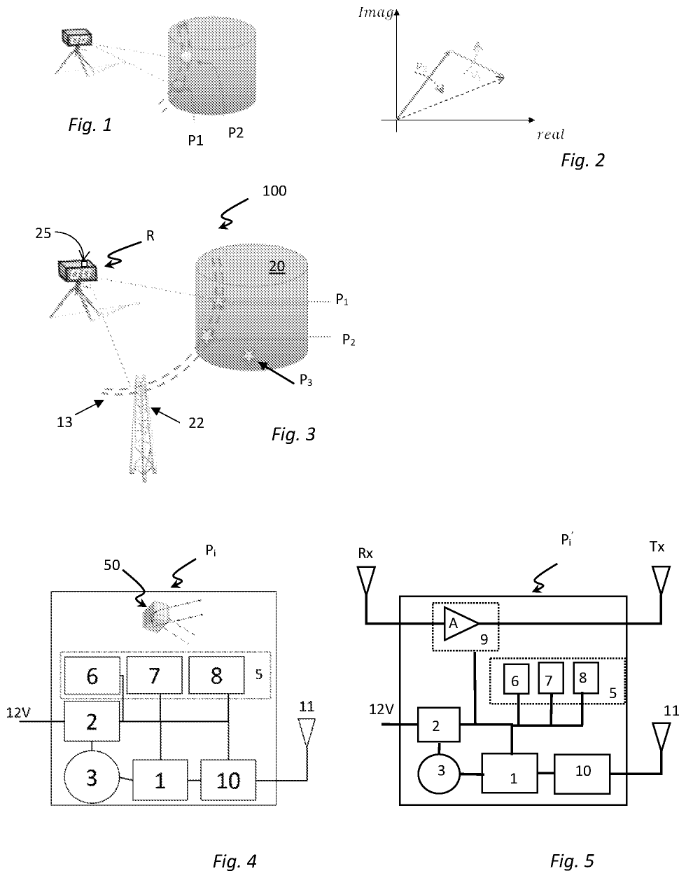

### DETAILED DESCRIPTION OF THE DRAWINGS

With reference to the Figures, a reflectometric system and a method for measuring vibrations or deformations of an object/structure 20 are described, according to the present disclosure. The system comprises at least one radar device R and a number of targets associated with the object/structure 20. According to the present disclosure and, as will become clearer in the following description, the targets are vibrating or mechanically active with vibrational motion induced at its own frequency f_{v,i} of induced vibration. In addition, the targets are also reflective Pᵢ. or electronically amplifying Pᵢ′. In the case of vibrating targets Pᵢ′ amplifying the signal sent by the radar device R is also amplified in amplitude before being transmitted.

The processing phase of the signals received by the radar device R takes place with a performing analysis that allows to distinguish or to separate the contributions of each vibrating target, Pᵢ or Pᵢ′ of interest, exploiting the a priori knowledge of the different and own frequencies f_{v,i} of induced vibrations or oscillations. The measurement of deformations and/or vibrations of the object/structure 20 is therefore determined on the basis of an estimate of the phase value of the contribution of each vibrating target Pᵢ of interest.

The reflectometric system 100 illustrated in FIG. 3 comprises the object/structure 20, which is a large tank, monitored by the radar device R by means of three targets P₁-P₃ associated with the external surface of the tank 20. Two of the three targets are iso-range, i.e., arranged in the same resolution cell 13. The P₃ target is external to the resolution cell 13 and therefore does not interfere with the measurement obtained from the Pᵢ and P₂ targets. The iso-range vibrating targets, P₁ and P₂, vibrate at a respective and own frequency, f_{v,1} e f_{v,2}, of induced vibration. Each vibrating target, Pᵢ and P₂, reflects or transmits by amplifying the Radar signals S_{IN}, sent by the radar device R, generating respective return signals, S_{OUT1} and S_{OUT2}. The return signals, S_{OUT1} and S_{OUT2}, are modulated on the basis of the induced vibrational displacement. Specifically, the return signals, S_{OUT1} and S_{OUT2}, have respective phases, φ₁(t) and φ₂(t), which are related to their induced frequency, f₁ and f₂, and to the instantaneous position of the target, Pᵢ and P₂, with respect to the tank 20. The complex signal s(t) received at time t by the receiving radar device R is given by the vector sum in the complex plane of the return signals, S_{OUT1} and S_{OUT2}, as schematically shown in FIG. 2.

In the example of FIG. 3, a reticular structure 22 or further reflective structures included in the same resolution cell 13 could generate reflected signals W as interfering contributions to the return signals, S_{OUT1} and S_{OUT2} and, therefore, considered as noise/disturbance. Said interfering reflected signals W are devoid of the induced vibrational motion.

In a first embodiment, shown in FIG. 4, the target Pᵢ is of the vibrating-reflective type and comprises a reflecting device or passive reflector 50 which allows for the reflection of the radar signals S_{IN} sent by the radar device R. The passive reflector 50 is shown as an additional element, however, the passive reflector 50 could be a nameplate or a portion of the target Pᵢ itself, provided that it has a reflective surface.

The vibrating-reflective target, Pᵢ, comprises a control unit 1, a power supply unit 2 and, interposed between them, a mechanical vibration mechanism equipped with an electric motor group 3. The control unit 1 can comprise a microprocessor and is configured to control the vibration frequency induced by the electric motor group 3.

In addition, the target, Pᵢ, may comprise a measurement module 5, with environmental sensors 6 such as temperature, humidity and pressure sensors and may further comprise an accelerometer 7 and/or an inclinometer 8. The sensors of the measurement module 5 are associated with the vibrating target, Pᵢ, and controlled by the control unit) via a communication bus. In this way, the electric motor group 3 can be controlled by the control unit 1 in an accurate and precise way, keeping its own frequency f_{v,i} of induced vibration or oscillation constant, also in relation to the environmental conditions, to the real acceleration detected by the accelerometer 7 and the data detected by the inclinometer 8.

In one embodiment, the sensors of the measurement module 5 can be made by means of one or more MEMS devices (acronym for Micro Electro-Mechanical System) allowing for the reduction of the effect of the interference generated in each Pᵢ target.

The electric motor group 3 can be, for example, a printed circuit motor, PCT motor or Printed Circuit Board motor.

According to the present disclosure, the electric motor group 3 is configured in such a way as to determine a self-induced vibrational motion with a half-oscillation range a_{v,i} greater than zero and no greater than 0.2 times the wavelength λ of the S_{IN} radar signal. Preferably, the self-induced vibrational motion has the half-oscillation range a_{v,i} not exceeding 0.1 times the wavelength λ of the S_{IN} radar signal. Semi-excursion of oscillation a_{v,i} refers to the oscillation from 0 to the peak value.

The vibrating target Pᵢ can comprise a wireless module with a wireless unit 10 which is equipped with a Wi-Fi antenna 11 and which is controlled by the control unit 1. The wireless unit 10 is configured to receive/send signals from/to a microprocessor processing unit 25 which, in one embodiment, is connected and communicating with the radar device R. The processing unit 25 comprises memories, registers and/or databases, in which the virtual operating data for each vibrating target Pᵢ are stored, especially data relating to the vibration motion and its own frequency f_{v,i} of induced vibration.

The signals received by the wireless module 10 comprise virtual data relating to the operating and control parameters of the electric motor group 3. According to one embodiment, the control unit 1 can modify its own frequency f_{v,i} of induced vibration or it can induce and control a timed ignition of the electric motor group 3 to generate its own induced vibrational motions diversified in predefined time intervals.

In the embodiment shown in FIG. 5, the vibrating target Pᵢ′ is an electronically amplifying target. The vibrating-amplifying target, Pᵢ′, comprises an active reflective device in place of the passive reflector 50. The active reflecting device comprises an amplification unit 9 to amplify the amplitude of the radar signal S_{IN} before it is transmitted as a return signal S_{OUT1}.

The vibrating-amplifying target Pᵢ′ may comprise a transceiver device Rx-Tx or, as shown, may comprise a first reception antenna Tx and a second transmission antenna Tx. The vibrating-amplifying targets Pᵢ′ allow for the amplification of the return signals S_{OUT1}, improving their visibility compared with the vibrating-reflective targets Pᵢ.

In one embodiment, the amplification unit 9 is substantially a bandpass amplifier, comprising three amplifiers A1, A2 and A3, connected in a chain with phase stability. The chain amplifier 9 is configured to provide a gain of approximately 20 dB in the K band, which is between 18-26 GHz, or a gain of approximately 50 dB in the W band, which is between 75-111 GHZ. In a preferred embodiment, the gain is approximately 50 dB in the W band between 77-81 GHz.

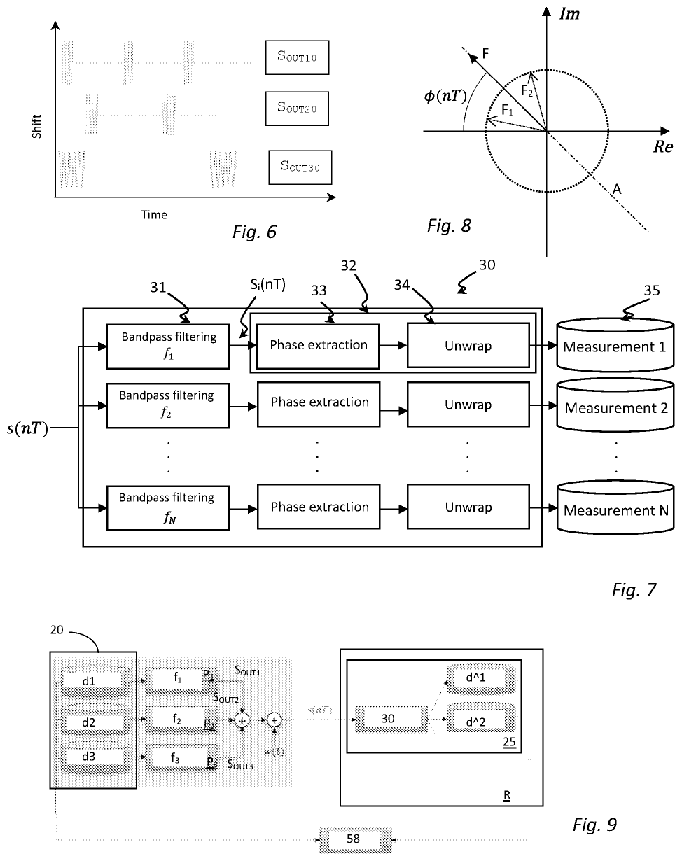

In FIG. 6, examples of three different return signals generated by three different induced vibrational motions are shown, which are configured to define shifts in both the time domain and the frequency domain, as evident in the S_{OUT10}, S_{OUT20} and S_{OUT30} signals shown. According to the present disclosure, the radar signal S_{IN} before being sent, reflected or transmitted as a return signal, S_{OUT1}, by the vibrating target, Pᵢ or Pᵢ′, is modified in phase, on the basis of its own induced vibration, f_{v,i}, generated by the electric motor 3 of the vibration mechanism, that determines a displacement with respect to the tank 20. Furthermore, the radar signal S_{IN} can be amplified by the amplification unit 9.

Naturally, each return signal, S_{OUT1}, received by the radar device R is also modulated in phase by the deformation or vibration of the tank 20 in correspondence with the vibrating target, Pᵢ o Pᵢ′, which defines the measurement term, d\hat{ }i(nT), of interest.

The full procedure of the method for determining the measurement, d\hat{ }i(nT), of deformations and/or vibrations of the tank 20 provides for the following:
a measurement phase, during which the radar signals, S_{IN}, sent by the radar device R, are received by two or more vibrating-reflective targets Pᵢ or vibrating-amplifying targets Pᵢ′ including iso-range, associated with said tank 20. These two or more vibrating targets being made according to what has previously described.

Therefore, said vibrating targets generate respective return signals, S_{OUT1} and S_{OUT2}, modulating, that is, reflecting or transmitting the amplified radar signals, S_{IN}, received at least on the basis of their own frequency, f_{v,i}, of induced vibration.

The method involves an acquisition phase, in which a single complex signal is received and processed by the receiving radar device R. The complex signal comprises the return signals, S_{OUT1} and S_{OUT2}, in addition to any interfering signals W or return signals S_{OUT3} of vibrating targets not of interest (or with its own frequency, f_{v,i}, being zero and, therefore, not vibrating and considered as noise or interfering signals). The complex signal in continuous time is indicated as a function s(t) and in discrete time it is indicated as s(nT), where T is the sampling period and n is an integer.

The complex signal s(nT) is then processed by the processing unit 25, which is associated with the radar device R, in real time during the acquisition phase or subsequently. The processing involves extracting from the complex signal s(nT) an identification signal Sᵢ(nT) associated with each vibrating target, Pᵢ and Pᵢ′, based on said own frequency f_{v,i} of induced vibration.

The method provides to determine a phase value, φᵢ(nT), for each identification signal, Sᵢ(nT), extracted and to estimate said measurement d\hat{ }i(nT) of deformations and/or vibrations of the tank 20 in correspondence with each vibrating target, Pᵢ and Pᵢ′, based on the respective phase value, φᵢ(nT), as determined.

In one embodiment, shown in FIG. 7, the processing unit 25 comprises a processing module 30 equipped with N processing branches for a respective number N of vibrating targets, Pᵢ and Pᵢ′, of interest and irradiated by the same S_{IN} radar signals. Each processing branch comprises a filtering unit 31 equipped with a bandpass filter and a phase estimation module 32 which allows for the definition, as an output, an estimate 35 of the deformation or vibration measurement d′i(nT) of the tank 20 for each Pᵢ and Pᵢ′ vibrating target.

Using the bandpass filter, the filtering unit 31 is responsible for extracting, from the complex signal s(nT), the contribution or identification signal Sᵢ(nT) associated with each vibrating target, Pᵢ and Pᵢ′. The extracted components are symmetrical components with a frequency equal to ±f_{v,i} on the basis of the virtual value of the own frequency, f_{v,i}, of induced vibration of each vibrating target, Pᵢ and Pᵢ′, which is stored by the processing unit 25.

The phase estimation module 32 comprises a phase extraction unit 33 suitable for extracting the phase term of the identification signal Sᵢ(nT) and an unwrap unit 34 which determines a continuous profile with multiples of 2n and which it allows for the definition, as output, of the estimate 35 of the measurement, d\hat{ }i(nT), of interest.

In particular, the complex signal s(nT) received by the radar device R, in the instant of time, nT, can be represented by the formula:

$$s ( nT ) = {\sum }_{i = 1}^{N} {ρ}_{i} {e}^{- j \frac{4 π}{λ} ( {R}_{0} + {a}_{v , i} sin ( 2 π {f}_{v , i} nT ) + {d}_{i} ( nT ) )} \qquad ( 1 )$$

where:
T is the sampling period, also referred to as the PRI (acronym for Pulse Repetition Interval) and is a default value;
N is the number of vibrating targets Pᵢ of interest irradiated, i.e., in the field of view, i.e., in the same resolution cell 13 with respect to the radar device R;
ρᵢ is the complex reflexivity of the target Pᵢ;
λ is the wavelength of the radar signal S_{IN};
R₀ is the initial distance from the radar device R to the vibrating target, Pᵢ or Pᵢ′, stationary, i.e., with zero induced vibrational motion;
a_{v,i} is the half-amplitude of the vibrational motion induced by the electric motor group 3 of the respective vibrating target;
f_{v,i} is the own induced vibration frequency for each vibrating target, Pᵢ e Pᵢ′;
di(nT) is the measurement of deformation or vibration measured over time nT by a respective vibrating target.

In one embodiment, considering for each vibrating target, Pᵢ or Pᵢ′, a sinusoidal motion as an induced vibrational motion, the return signal S_{OUT1} (nT) is given by the sum of infinite sinusoids with a frequency multiple of its own induced frequency f_{v,i} and an amplitude imposed by the possible amplification induced by the amplification unit 9.

The return signal S_{OUTi}(nT) for each vibrating target Pᵢ or Pᵢ′ can be described as follows:
(2)

$${S}_{OUTi} ( nT ) = {e}^{- j \frac{4 π}{λ} {d}_{i} ( nT )} {\sum }_{k = - ∞}^{+ ∞} {J}_{k} ( β ) {e}^{jk {ω}_{i} nT}$$

Where:

$$β = \frac{4 π}{λ} {a}_{v , i}$$

$${ω}_{i} = 2 π {f}_{v , i}$$

Jₖ(β) represents the amplitude of the spectral component at frequency kf_{v,i}, assessed in β and correlated for each vibrating target, Pᵢ or Pᵢ′. A term proportional to the amplification and attenuation due to propagation has not been included in formula 2, as is clear to the person skilled in the art.

Therefore, with N vibrating targets, Pᵢ and Pᵢ′, in the same resolution cell 13, the complex signal s(nT) received by the radar R can be represented by the sum of N return signals S_{OUTi}(nT), i.e.:

$$s ( nT ) = {e}^{- j {ϕ}_{1} ( nT )} {J}_{0} ( β ) + \text{?} {J}_{1} ( β ) {e}^{j {ω}_{1} nT} + {e}^{- j {ϕ}_{1} ( nT )} {J}_{2} ( β ) {e}^{j 2 {ω}_{1} nT} + … {e}^{- j {ϕ}_{2} ( nT )} {J}_{0} ( β ) + \text{?} {J}_{1} ( β ) {e}^{j {ω}_{2} nT} + {e}^{- j {ϕ}_{2} ( nT )} {J}_{2} ( β ) {e}^{j 2 {ω}_{2} nT} + … \qquad ( 3 )$$

$$\text{?} \text{indicates text missing or illegible when filed}$$

For simplicity, formula (3) is reported for N equal to two, a first vibrating target Pᵢ, first row, and a second vibrating target P₂ second row. For each vibrating target, Pᵢ and Pᵢ′, the measurement d\hat{ }i(nT) of interest is related to the phase end of the respective identification signal Sᵢ(nT) extracted considering the fundamental harmonic, according to the following equation:

$${ϕ}_{i} ( nT ) = \frac{4 π}{λ} {d}_{i} ( nT ) \qquad ( 4 )$$

In one embodiment, the phase term extraction unit 33 considering a number N_{c} of consecutive samples, with the value of the phase ϕᵢ(nT) constant, and maximises, with respect to the phase ϕ, the identification signal Sᵢ(nT) counter-rotated by a value, ϕ, in the real part squared according to the following function:

$$= {argmax}_{ϕ} \frac{1}{{N}_{c}} {\sum }_{i = n - {N}_{c} / 2}^{n + {N}_{c} / 2} {( Re \{ {s}_{i} ( iT ) {e}^{j ϕ} \} )}^{2} \qquad ( 5 )$$

Therefore, the estimate 35 of the measurement d\hat{ }ᵢ(nT) of interest is obtained by considering the continuous profile (by means of the unwrap⁽⁶⁾ function) of the estimate of the phase ϕᵢ(nT) term, by means of:

$$= \frac{λ}{4 π} {ϕ}_{iu} ( nT )$$

Advantageously, for each vibrating target the formula (5) averages the values of the N_{c} samples allowing to cancel the slow displacement or vibrational displacement induced by the vibration of the vibrating target, Pᵢ and Pᵢ′, itself.

According to the present disclosure, the self-induced motion of each vibrating target, Pᵢ and Pᵢ′, has a half-oscillation range a_{v,i} greater than zero and not greater than 0.2 times the wavelength λ of the S_{IN} radar signal. Preferably, this half-oscillation range a_{v,i} is not greater than 0.1 times the wavelength λ of the S_{IN} radar signal. In this way, the first harmonic of said output signal S_{OUT1} (nT) is the dominant harmonic.

In one embodiment, the bandpass filter 31 can be a FIR or IIR filter, acronyms of Finite Impulse Response and Infinite Impulse Response respectively, with bandwidths in the order of a few Hz. The Fourier transform of the bandpass filter is symmetrical and allows you to extract the components of k=1 and k=−1 in equation 2) specified above.

Specifically, each filtered identification signal sᵢ(nT) can be represented by:

$${s}_{i} ( nT ) = \text{?} {J}_{1} ( {β}_{1} ) {e}^{j {ω}_{1} nT} + \text{?} {J}_{1} ( {β}_{1} ) {e}^{- j {ω}_{1} nT} + {w}_{F} ( nT ) \qquad ( 7 )$$

$$\text{?} \text{indicates text missing or illegible when filed}$$

where ϕ₁(nT) represents the phase term to be monitored and related to the measurement d\hat{ }i(nT) of interest,
e^{jω}^{₁}^{nt} and e^{-jω}^{₁}^{nt} represent the components of the first harmonic for k=1 and k=−1;
W_{F}(nT) represents the filtered noise.

As evident to a person skilled in the art, the filtered identification signal Sᵢ(nT) (equation 7) can be represented graphically in the complex plane Re-Im and for a fixed instant of time nT as illustrated in FIG. 8. The two phasers, F₁ and F₂, with angular speed ω₁, rotate: one clockwise and the other counter-clockwise. The vector sum of the phasers, F1 and F2, determines the vector F which represents the identification signal Sᵢ(nT).

For a stationary vibrating target, Pᵢ, i.e., with vibrational displacement but without deformation of the object/structure 20, the sum of the phasers, F1 and F2, runs along the bisector line A. With a deformation or vibration of the object/structure 20, there is an inclination of the line A and this inclination is correlated to the aforementioned measurement, d\hat{ }i(nT), of interest. Therefore, the processing with the estimation unit 32 allows for the estimation of the deformation or vibration measurement over time, substantially determining the slope of the straight line given by the sum of the two phasers, F₁ and F₂. As is evident, the previous equation (5) consists in counter-rotating the vector F given by the sum of the two rotating phasers, until the counter-rotating angle that maximises the real part of the squared signal is found.

The measurement, d\hat{ }i(nT), of interest determined with the present disclosure is advantageously free from interference from other stationary or vibrating objects at frequencies not of interest. Therefore, the measurement system and method were found to be particularly precise and versatile.

By means of the system and the method, according to the present disclosure, it is possible to determine whether the measurement, d\hat{ }i(nT), of interest estimated has been generated by an event external to the object/structure 20 and, in this case, correct or compensate for the estimated value of the measurement t of interest. Through the measurement module 5, the environmental sensors 6 detect the data, such as temperature, humidity and pressure, for instance, in a timed sequence and, in a known mode, can be included in the return signal S_{OUT1} to be then processed by the processing unit 25.

Furthermore, according to the present disclosure, it is possible to determine the temporal origin of a deformation or vibration of an object/structure 20 using a cross-correlation and a mathematical model. For example, by means of the temperature sensor of module 6 and/or further temperature sensors associated internally with the tank 20, so as to monitor the temperature of the fluid contained, it is possible to detect the temperatures and correlate these values detected with the estimated values of the measurements d\hat{ }i(nT) of interest, obtained through the present disclosure. For instance, it is possible to correlate the temperature of the fluid contained in a tank 20 with the deformation of the steel with which the tank 20 itself is made.

Furthermore, it is also possible to estimate the delay of each return signal S_{OUTi} due to atmospheric disturbances in the distance from the radar device R to the target, Pᵢ. The phase of the return signal, S_{OUT1}, at a given time t, can be expressed by the following function:
(8)

$${ϕ}_{P} ( t ) = {ϕ}_{0 , P} + \frac{4 π}{λ} ( {R}_{P} ( t ) + {R}_{atm , P} ( t ) ) \qquad ( 8 )$$

where: ϕ_{0,P} is the backscatter phase of the target (P);
R_{P}(t) is the geometric distance between the radar device R and the target P;
R_{atm,P}(t) is the additional atmospheric delay which can be expressed as a function of the parameters: temperature, humidity and pressure, according to known formulas. The additional atmospheric delay can be considered constant in the analysed space and considering N the refractive index of the atmosphere, we have N(P,t)=N(t). Therefore, the additional atmospheric delay can be expressed as follows:

$${R}_{atm , P} ( t ) = {10}^{- 6} \int N ( t ) dl = {10}^{- 6} N ( t ) {R}_{P} \qquad ( 9 )$$

Once the R_{atm,P} value has been determined for each pixel and for each detected image, it is possible to determine the phase with the function

$${ϕ}_{atm , P} ( t ) = \frac{4 π}{λ} {R}_{atm , P} ( t ) \qquad ( 10 )$$

and then determine the phase compensated with the following:

$${ϕ}_{comp} ( t ) = {ϕ}_{P} ( t ) - {ϕ}_{atm , P} ( t ) \qquad ( 11 )$$

### Simulation

The Applicant has carried out various simulations to verify the functionality and goodness of the method and of the proposed system. FIG. 9 shows the simulation scheme used with three targets, Pᵢ-P₃, iso-range associated with an object/structure and configured to detect corresponding deformations. Vibrational motion is induced in each target, P₁-P₃, at the predefined induced frequency, f₁, f₂ and f₃. Each target, Pᵢ-P₃, reflects or transmits the radar wave, S_{IN}, to the receiving radar device R. The received complex signal, s(nT), includes the return signals, S_{OUT1}-S_{OUT3} and can also include interfering signals W and, amongst the latter, also noise with Gaussian amplitude and constant spectrum, i.e., white Gaussian noise.

Further simulation specifications are as follows:
the radar device (R) has a PRF Radar value of 500 Hz and a simulation time of 1 hour.
the vibrating targets have the characteristics shown in the following Table:

| | Average | Own | |
|---|---|---|---|
| | Deformation | Vibration [Hz] | Vibration |
| | rate [μm/s] | Frequency f_{v, i} | amplitude [mm] |
| Vibrating | −0.5 | 78 | 0.26 |
| target P₁ | | | |
| Vibrating | 0.2 | 100 | 0.28 |
| target P₂ | | | |
| Vibrating | 0 | 0 | 0 |
| target P₃ | | | |

The vibrating target P₃ has zero as its own frequency f_{v,i} of induced vibration motion; thus it was considered not of interest for the estimation of the measurement, d\hat{ }i(nT).

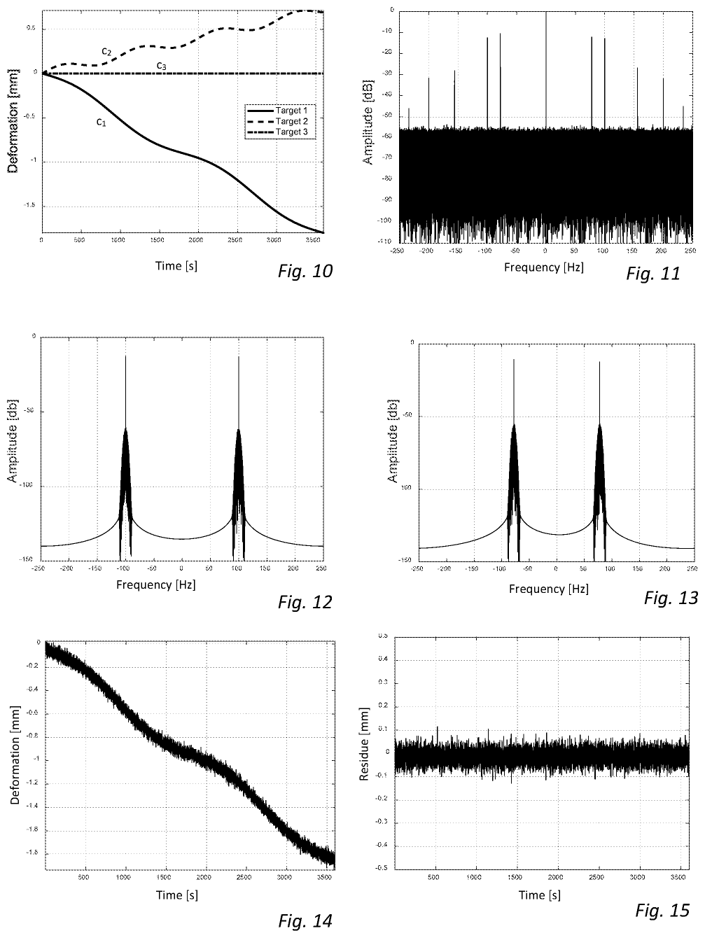

The simulation with the processing module 30 allows for the determination of the values of the estimated measurements d\hat{ }₁(nT), d\hat{ }₂(nT). FIG. 10 shows the simulated deformation of each vibrating target P₁-P₃ over time (d1, d2, d3 as per FIG. 9). The deformation curve c1 of the vibrating target Pᵢ represents a movement of the target away from the radar device R. Meanwhile, the deformation curve c2 relative to the target, P₂, represents a movement of the target approaching the radar device R.

FIG. 11 shows the complex signal s(nT) in the frequency domain with the frequency components 0 Hz, 78 Hz and 100 Hz, of the first harmonic and subsequent harmonics. FIGS. 12 and 13 show, respectively, the signal filtered through the bandpass filter 31 around 100 Hz and 78 Hz. Specifically, a FIR filter of order 256 was used, in which the band is 6 Hz and the attenuation band is 180 dB.

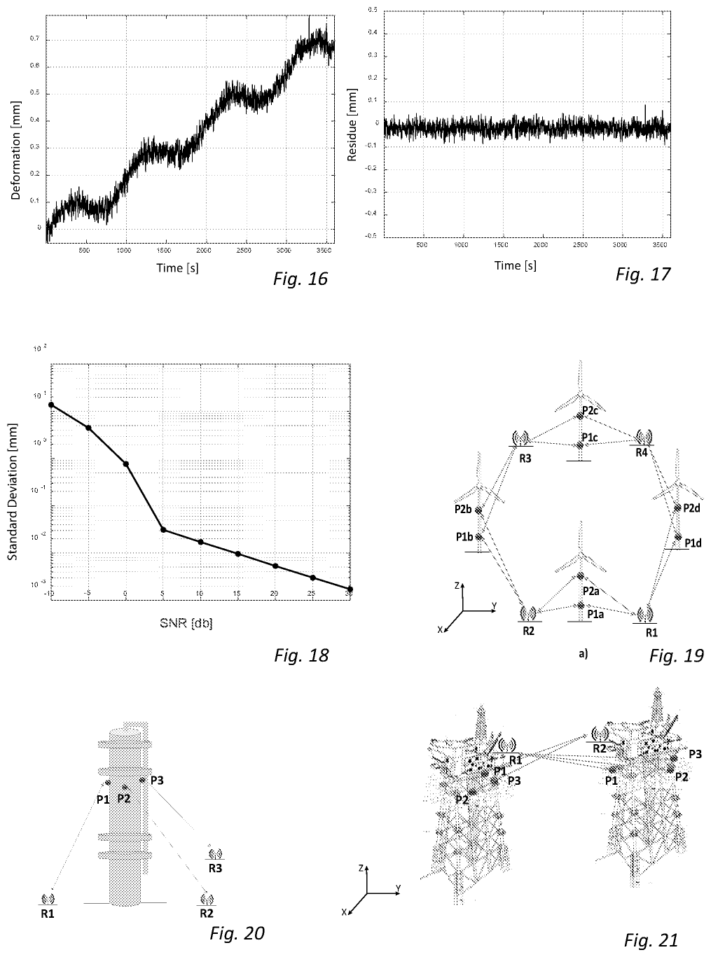

FIGS. 14 and 16 respectively show the curves of the estimated values of the d\hat{ }i(nT) measurements and of the real values of the measurements relating to the vibrating targets, Pᵢ and P₂. Essentially, the two curves shown overlap, thus confirming the effectiveness of the processing process according to the present disclosure. This effectiveness is also confirmed by the trend, over time, of the residuals of the estimated values of the d\hat{ }i(nT) measurements shown in FIGS. 15 and 17.

A retrospective assessment of the accuracy of the estimate of the measurement, d\hat{ }i(nT), of interest, according to the present disclosure, is analysed by calculating the residual standard deviation, using the following formula:

$${σ}_{d} = \sqrt{\frac{1}{N} {\sum }_{n = 1}^{N} {( - {d}_{i} ( nT ) )}^{2}} \qquad ( 12 )$$

Where:
[symbol] is the estimated measurement;
dᵢ(nT) is the actual measurement;
N is the total number of samples considered in the formula (5).

FIG. 18 shows the standard deviation of the estimated value of the measurement, d′i(nT), as a function of the signal/noise ratio (SNR). With the increase in the signal/noise ratio, the estimated value of the measurement d\hat{ }i(nT) improves until it reaches μm values. It has been observed that, with a signal/noise ratio of 13 dB, the likelihood of a false alarm is equal to 10-5 and the likelihood of a correct detection equal to 0.9 and, therefore, the estimate of the value of the measurement d\hat{ }i(nT) of interest is approximately 10 μm.

FIGS. 19-21 show some examples in which the system and method, according to the present disclosure, are used. In FIG. 19, the system is used in a wind power plant; in FIG. 26, the system monitors a distillation column used in a refinery, whilst in FIG. 26, the system is used for cross-monitoring of the lattice support structures of two facilities.

It has been found that the system and the method conceived have achieved the intended aim and objects and are suitable for extrapolating, from the complex signal received from the radar device, the signal transmitted by each target, even in the case of iso-range on the basis of the mechanical modulation induced by the electric motor group activated in each vibrating target. This allows for the ease of separating the signals received using the interferometric technique, obtaining estimated values of the measurements of interest relating to the vibrations or deformations of the object/structure that are increasingly precise and performing.

1. A reflectometric system for the measurement (d\hat{ }i(nT)) of deformations and/or vibrations of an object/structure, the system being equipped with a radar device (R) suitable for transmitting a radar signal (S_{IN}) to at least one target associated with said object/structure,
said at least one target is a vibrating target (Pᵢ,Pᵢ′) which comprises a vibration mechanism equipped with an electric motor group to generate a self-induced motion with respect to said object/structure with its own frequency (f_{v,i}) of induced vibration, said at least one vibrating target (Pᵢ,Pᵢ′) modulating said radar signal (S_{IN}) at least on the basis of said its own frequency (f_{v,i}) of induced vibration to generate a return signal (S_{OUTi});
said radar device (R) is connected to a processing unit that is configured to receive and to process a complex signal (s(nT)) comprising said return signal (S_{OUTi}) and to extract from said complex signal (s(nT)) an identification signal (Sᵢ(nT)) of said at least one vibrating target (Pᵢ,Pᵢ′) using said its own frequency (f_{v,i}) of induced vibration, and
said processing unit is configured to extract a phase value (φᵢ(nT)) from the identification signal (Sᵢ(nT)) of each vibrating target (Pᵢ,Pᵢ′) and to estimate said measurement (d\hat{ }i(nT)) of deformations and/or vibrations on the basis of the phase value (φᵢ(nT)) extracted from said identification signal (Sᵢ(nT)) of each vibrating target (Pᵢ,Pᵢ′).

2. The system according to claim 1, wherein said at least one vibrating target (Pᵢ,Pᵢ′) comprises a control unit equipped with a microprocessor to control its own frequency (f_{v,i}) of induced vibration which is induced by the electric motor group, said at least one vibrating target (Pᵢ,Pᵢ′) further comprising a reflecting device, said reflecting device being a passive reflector type or an active reflector type comprising an amplification unit.

3. The system according to claim 1, wherein said vibration mechanism is configured to determine the self-induced motion with a half-oscillation range (a_{v,i}) greater than zero and not greater than 0.2 times the wavelength (λ) of said radar signal (S_{IN}); preferably said half-oscillation range (a_{v,i}) is not greater than 0.1 times the wavelength (λ) of the radar signal (S_{IN}).

4. The system according to claim 2, wherein said at least one vibrating target (Pᵢ, Pᵢ′) comprises a measurement module equipped with at least one environmental sensor, an accelerometer and/or an inclinometer and/or by the fact that said system comprises a wireless module configured to receive/send signals from/to said processing unit, the measurement module and the wireless module being controlled by the control unit.

5. The system according to claim 1, wherein said processing unit comprises a processing module equipped with a processing branch for each of said at least one vibrating target (Pᵢ, Pᵢ′), each processing branch comprising:
a filtering unit equipped with a bandpass filter that filters said complex signal (S(nT)) on the basis of said own frequency (f_{v,i}) of induced vibration, generating said identification signal (Sᵢ(nT)); and
a phase estimation module comprising a phase term extraction unit suitable for extracting a phase term (ϕᵢ(nT)) of said identification signal (Sᵢ(nT)) and an unwrap unit which allows for the definition of an estimate of said measurement (d\hat{ }i(nT)) from said phase term (ϕᵢ(nT)).

6. A method for the measurement of deformations and/or vibrations of an object/structure comprising a measurement phase which involves transmitting at least one radar signal (S_{IN}) from a radar device (R) to at least one target associated with said object/structure, the method including the following steps:
equipping said at least one target with a vibration mechanism comprising an electric motor group to generate at least one vibrating target (Pᵢ,Pᵢ′) with a self-induced motion with respect to said object/structure, said at least one vibrating target (Pᵢ,Pᵢ′) having its own frequency (f_{v,i}) of induced vibration;
generating return signals (S_{OUTi}) by modulating said radar signal (S_{IN}) at least on the basis of said own frequency (f_{v,i}) of self-induced vibration of said at least one vibrating target (Pᵢ,Pᵢ′);
receiving and processing a complex signal (s(nT)) comprising said return signal (S_{OUT1});
extracting from said complex signal (s(nT)) an identification signal (Sᵢ(nT)) of each at least one vibrating target (Pᵢ,Pᵢ′) on the basis of said its own frequency (f_{v,i}) of induced vibration;
extracting a phase value (φᵢ(nT)) by processing said identification signal (Sᵢ(nT)) of each vibrating target (Pᵢ,Pᵢ′); and
estimating said measurement (d\hat{ }i(nT)) of deformations and/or vibrations on the basis of said phase value (φᵢ(nT)) extracted from said identification signal (Sᵢ(nT)) of each vibrating target (Pᵢ,Pᵢ′).

7. The method according to claim 6, whereby controlling said its own frequency (f_{v,i}) of induced vibration of said electric motor group by means of a control unit equipped with a microprocessor and by providing said at least one vibrating target (Pᵢ,Pᵢ′) with a reflecting device, said reflecting device being a passive reflector or an active reflector type comprising an amplification unit.

8. The method according to claim 6, whereby determining said self-induced motion with a half-oscillation range (a_{v,i}) greater than zero and not greater than 0.2 times the wavelength (λ) of said radar signal (S_{IN}), preferably said half-oscillation range (a_{v,i}) being not greater than 0.1 times the wavelength (λ) of the radar signal (S_{IN}).

9. The method according to claim 6, whereby processing separately said complex signal (S(nT)) for each of said at least one vibrating target (Pᵢ, Pᵢ′) includes the following steps:
filtering said complex signal (S(nT)) with a bandpass filter on the basis of said own frequency (f_{v,i}) of induced vibration to generate said identification signal (Sᵢ(nT)); and
extracting a phase term (ϕᵢ(nT)) of said identification signal (Sᵢ(nT)) and identifying a continuous profile of said phase term (ϕᵢ(nT)) by means of an unwrap unit.

10. The method according to claim 6, whereby determining the phase term (ϕᵢ(nT)) extracting a number Nc of consecutive samples and maximising said identification signal (Sᵢ(nT)), counter-rotated by a phase ϕ, in the real part squared according to the following function:
$$= {argmax}_{ϕ} \frac{1}{{N}_{c}} {\sum }_{i = n - {N}_{c} / 2}^{n + {N}_{c} / 2} {( Re \{ {s}_{i} ( iT ) {e}^{j ϕ} \} )}^{2}$$
